(19) United States
(12) Patent Application Publication
(10) Pub. No.: US 2024/0420524 A1
(43) Pub. Date: Dec. 19, 2024

(54) Recording Method for Independent Evidence and Complete Facts in Intelligent Driving Accidents

(71) Applicant: Xiaoxiao CHEN, Chengdu, Sichuan (CN)

(72) Inventor: Xiaoxiao CHEN, Chengdu, Sichuan (CN)

(21) Appl. No.: 18/714,559

(22) PCT Filed: Feb. 23, 2023
(86) PCT No.: PCT/CN2023/077765

§ 371 Date: May 29, 2024

(30) Foreign Application Priority Data
Mar. 14, 2022 (CN) 202210244642.0

(51) Int. Cl. G07C 5/08

(52) U.S. Cl. CPC G07C 5/085

(57) ABSTRACT

In intelligent driving, various unexpected events such as errors, failures, anomalies, etc. may occur in perception, positioning, planning, control, human-machine interaction and other aspects, making users feel puzzled, uncomfortable, uneasy, dissatisfied, and even encountering accidents. This patent uses non-vehicle equipment to capture and record independent evidence related to the unexpected events, mainly through targeted video-shooting from multiple perspectives and positions in a time-synchronized manner, to record the detailed and continuous performance of people and vehicle throughout the entire process before, during and after such unexpected events, especially the artificial intelligence related performance, in order to form a comprehensive, complete, clear and accurate factual information record that can be reproduced about the causes and consequences of intelligent driving unexpected events, help user record accidental encounter and safeguard legitimate rights and interests.

### CROSS-REFERENCE TO RELATED APPLICATIONS

This application claims priority benefit to China Utility Patent Application No. 202210244642.0, application filing date is Mar. 14, 2022 (Patent No. CN114454832B, patent authorization date is Jul. 7, 2023), and, this application is National Stage entry into US from PCT International Application No. PCT/CN2023/077765, international application filing date is Feb. 23, 2023, earliest priority date is Mar. 14, 2022, the disclosures of which are incorporated herein by reference in their entirety.

### BACKGROUND OF THE INVENTION

In recent years, there has been an increasing application of various intelligent driving products, such as automatic driving, autonomous driving, assisted driving, and human-machine co-driving. Due to the strong correlation between intelligent driving and safety (personal safety, property safety, public safety), consumers, users, industry, society, and governments have maintained high vigilance and strict requirements for intelligent driving products. The vast majority of intelligent driving products require users to remain focused on driving conditions and intervene to take over vehicle when necessary, whereof the users themselves taking legal responsibility for driving results. While enjoying the convenience brought by intelligence, users often meet various problems with intelligent driving in various aspects such as perception, positioning, planning, control, human-machine interaction, etc. In application practice, when users encounter various unexpected events such as errors, failures, and abnormalities in intelligent driving, they often experience confusion and panic, there are many times when users are more scared than hurt, but sometimes real accidents still occur. In addition, conservative design under safety considerations often affects the ease of use, and the conditions for intervention and takeover vary from person to person on a case by case basis. Users often have to fall into the contradiction of “believing in intelligent driving” and “not believing in intelligent driving”, and even feel more tired and tense than manual driving during such intelligent driving. For various accidents caused by intelligent driving, users generally find it difficult to fully and completely record the objective process and subjective experience after the accidents, through memory alone, even if they experience confusion, discomfort, unease, and dissatisfaction, they lack the ability to recall comprehensive details and to speculate about logical reasons, but can only vaguely recall that “at the moment it all happened too fast”, “specific details cannot be remembered clearly”, “too dangerous”, “my brain was completely blank”. In some cases, even if the driver or person on board take reasonable intervention as soon as possible when discover an intelligent driving error, it is no longer effective. In other cases, intelligent vehicles autonomously take actions that violate traffic restrictions causing users to be punished, the users often cannot appeal but can only admit misfortune. Therefore, in the market application and social practice of intelligent driving, users often raise objections and doubts about the safety and ease of use of such products, and then further attempt to seek help from product manufacturers or submit complaints to regulatory authorities, however, it is difficult to fully, completely, clearly, and accurately describe such issues or reproduce such events with simple language. When users believe that the intelligent driving function or product has quality issues or performance defects, and try to protect their legitimate rights and interests, it is also difficult to independently provide comprehensive and complete evidence. For a long time, users who have experienced unexpected events in intelligent driving have felt that they are unable to express or prove their bitterness, so they urgently need some technical solution. On the other hand, the intelligent driving function has also been considered of little value in the eyes of some users, and manufacturers are unable to receive rich problem cases to help improve the products, delaying or even misleading the progress of the intelligent vehicle industry. Currently, traditional and common automotive Event Data Recording systems (EDR) and Driving Video Recording systems (DVR) cannot fully solve the above problems for users.

### SUMMARY OF THE INVENTION

In intelligent driving, various unexpected events such as errors, failures, anomalies, etc. may occur in perception, positioning, planning, control, human-machine interaction and other aspects, making users feel puzzled, uncomfortable, uneasy, dissatisfied, and even encountering accidents. This patent uses non-vehicle equipment to capture and record independent evidence related to the unexpected events, mainly through targeted video-shooting from multiple perspectives and positions in a time-synchronized manner, to record the detailed and continuous performance of people and vehicle throughout the entire process before, during and after such unexpected events, especially the artificial intelligence related performance, in order to form a comprehensive, complete, clear and accurate factual information record that can be reproduced about the causes and consequences of intelligent driving unexpected events, help user record accidental encounter and safeguard legitimate rights and interests.

In summary, this patented method is: using non-vehicle-equipped camera devices and data storage devices, during the operation of the intelligent vehicle, continuously and simultaneously video-shoot and record the external environment of the vehicle, the driver's hand operation positions, the driver's foot operation positions, and the human-machine interaction interfaces in a time-synchronized manner, in order to record the difference, discrepancy or conflict between “cognition, decision-making and execution out of machine” and “purpose, intention and thought out of human”, and independently record the entire process of intelligent driving accidents, in which, the video-shooting at the driver's foot operation positions is mainly targeted to record which specific stepping device the foot stepped on, the degree to which the stepping device was stepped down, and the specific range of the foot-stepping action, the video-shooting of human-machine interaction interfaces is mainly targeted to record information related to intelligent driving among all information displayed. In addition, simultaneously and time-synchronously video-shoot and record person or goods inside the vehicle, use non-vehicle-equipped device to receive time information and positioning information provided by external radio signals and synchronize with the video, use non-vehicle-equipped device to perform time-synchronized audio acquisition and recording, set shooting illumination at the shooting position, and all records are stored, copied, and played in a time-synchronized manner, and the data storage device on the vehicle is seal-protected to withstand collision, fire or flooding, without damage or loss.

By synchronizing and playing the entire process of video and audio with time and positioning information, the entire process of the unexpected causes and consequences in intelligent driving unexpected events can be fully and completely reproduced. Users can use such process reproduction as basis and evidence to defend their rights against manufacturers and demand compensation, or to complain to regulatory authorities, or to initiate legal proceedings. Users have the right to claim that “such intelligent driving artificial intelligence has product defects and safety hazards”, “such intelligent driving products are incompetent with insufficient capability”, “the intelligent driving products manufacturers should be partially or fully responsible for traffic violation penalties or accidents caused by intelligent driving”, etc.

### DETAILED DESCRIPTION OF THE INVENTION

The intelligent driving encounters errors, failures, and abnormalities. Some typical cases that users have experienced are listed below.

Perception aspect of intelligent driving. Case 1: The intelligent driving vehicle mistakenly perceives a normal driving environment without obstacles, believing that “there are dangerous obstacles”, causes the vehicle to automatically perform sharp deceleration or emergency braking, known as the “ghost braking” or “phantom braking” phenomenon, which scare users and even lead to meaningless rear end collisions; Case 2: The intelligent driving vehicle mistakenly perceives a dangerous driving environment with obstacles ahead, believing that “there are no obstacles”, causes collision accidents between the high-speed vehicle and the obstacles ahead, even if the driver intervenes at a reasonable reaction speed; Case 3: The normally high-speed intelligent driving vehicle mistakenly perceives the numbers on roadside billboards as speed limit signs, or mistakenly perceives the roadside signs of a certain fast food chain as stop signs, or mistakenly perceives the moon as a yellow light of traffic light, causes the vehicle to “inexplicably” decelerate or brake to a stop, causes fear to users, and causes obstruction and blocking to the following vehicles of the normal traffic; Case 4: The normally high-speed intelligent driving vehicle on the highway mistakenly perceives several white stains on the road surface in front of the right front wheel as the lane markings, causes it to deviate from the normal lane to the left and almost collide with the cement isolation strip in the middle of the road, fortunately the driver remains focused and intervenes in a timely manner at the place extremely close to the isolation strip, quickly turning the steering wheel to the right and pulling the vehicle back to the normal lane, however, even so, due to the large range of emergency pull back action, the vehicle still performs an unsafe and unstable state of rapid swaying left and right, and only regains stability a few seconds later, during this process, it almost collides with nearby vehicles on the right side of the lane, causes the nearby vehicles to panic and make evasive maneuvers; Case 5: A plastic bag suddenly appears in front of the intelligent driving vehicle that is driving normally at high speed on the highway. If it is human drivers driving manually, they can instantly determine that “the plastic bag will not have a substantial impact on the vehicle” and then easily drive through it normally, however, the artificial intelligence of the intelligent vehicle is unable to understand “texture” or “material” and simply perceives such object as “a dangerous obstacle” and then leads to emergency full speed braking, causing panic to users and even leading to meaningless rear end collisions; Case 6: The roadside traffic sign “STOP” is stained with a small amount of mud, the intelligent driving vision artificial intelligence mistakenly perceives it as “SPEED LIMIT 45 (speed limit of 45 miles/hour)”. Or, the roadside traffic sign “Allow straight or right turn” is perturbatively marked with light spots by some light passing through gaps between roadside tree leaves, the intelligent driving vision artificial intelligence mistakenly perceives it as “Allow straight or left turn”. Or, on the roadside traffic sign “SPEED LIMIT 60 km/h”, a diagonal light strip is formed due to reflection, intelligent driving vision artificial intelligence mistakenly perceives it as “release the speed limit 60 km/h”. Under such similar noises, perturbations or disturbances, the intelligent vehicle fails to take correct and appropriate planning and actions according to traffic requirements due to perception errors. During process of such events, even if the driver realizes that the intelligent driving is making mistakes, the maneuvering action has already been taken, even immediate intervention is no longer effective (for example, the violation maneuvers have been captured by traffic monitoring cameras), resulting in traffic violation penalties and even accidents; Case 7: The intelligent vehicle perceives a small amount of water column, water curtain, and water mist that suddenly appear in front of it as obstacles and takes emergency braking. For example, in scenarios where the automatic watering system in the roadside green belt accidentally sprays water too far into the road area, the tunnel arch is occasionally damaged and leaking some water curtain, the road sprinkler sprays water to wash the road surface, or the high-density water mist sprayed by smog-reducing water-cannon truck falls from the sky, emergency braking may cause discomfort or even unnecessary rear end collision.

Positioning aspect of Intelligent Driving. Case 8: Intelligent driving vehicles under elevated bridges, entering and exiting tunnels, or beside urban high buildings easily encounter positioning errors such as positioning jumps, which lead to vehicles mistakenly recognizing their precise positions and automatically taking maneuvering actions based on incorrect positioning on digital maps. Improper, incorrect, and even dangerous driving behaviors can cause fear and panic to users, as well as to nearby vehicles, and even lead to accidents.

Planning aspect of intelligent driving. Case 9: The intelligent driving vehicle waits for other traffic participants to pass at a slightly busy intersection, due to complex calculative logic, conservative program settings, or delayed decision-making pace, the vehicle stops and waits for an unusually long time, and the user expresses confusion and dissatisfaction. Helplessly, they can only manually take over and then smoothly drive through the intersection themselves at the end; Case 10: Facing a newly constructed and open-access road, intelligent driving vehicle completely “ignores” the new road and still chooses old detour route, and the users experience confusion and dissatisfaction.

Control aspect of intelligent driving. Case 11: When the intelligent driving vehicle cannot perceive the lane line on one side (for example, the lane line on one side of the lane “fades”), it significantly sways left and right to search for the lane markings and attempt to center itself, causing panic to users and nearby vehicles; Case 12: When following in traffic congestion, for safety reasons, intelligent driving vehicles need to sensitively detect whether there are vehicles in the next lane that are too close for dangerous merging (so-called “cut in line”), however, users actually experience that, whenever the wheels of the next vehicle slightly press onto the lane markings, even if the actual distance is far or relative speed is low, the intelligent vehicles also take unnecessary emergency braking action, resulting in a poor user experience; In case 13: In the driving experience, users believe that “they did step on the brake pedal, but the vehicles did not brake and even accelerated”, leaving behind the experience and memory of “the vehicle did not obey commands” and “the brake pedal could not be stepped down”. In such cases, users are unable to determine but can only passively refer to and believe the data from the manufacturer and the conclusions given by traffic management authority. Even if the users are very confident in their driving experience and memory, there is no conclusive evidence to raise objections to the manufacturer's potential quality issues.

Human-machine interaction aspect in intelligent driving. Case 14: Occasionally, the intelligent driving function or mode suddenly exits without forewarning, prompting the driver to take over immediately, causing the driver to be caught off guard and into a panic flurry, causing shock, confusion, and dissatisfaction to users; Case 15: In some scenarios where intelligent driving itself creates a dangerous situation, frightened human drivers violently intervene trying to take over the vehicle, causing excessive or inappropriate actions which unexpectedly leads to traffic accidents.

For various aspects and situations mentioned above, users have the willingness and need to independently collect audio and video evidence and record the entire process of such intelligent driving unexpected events. They hope to collect and record complete facts related to intelligent driving performance and human-machine interaction, and can reproduce them in the most intuitive way. They hope, when question the performance of intelligent driving products or safeguard their legitimate rights and interests, some complete and comprehensive evidence can be served. They hope to synchronously collect videos of the external traffic environment of the vehicle (Such as what kind of obstacle is mistakenly perceived and the process of collision with the obstacle), videos of the driver's steering wheel position (Such as the reaction process under panic and danger when the driver intervenes in an emergency, and whether the action is appropriate), videos of the driver's operating lever position (Such as when the commands are given, what commands are given, what specific hand operations are made, and whether the operations are appropriate), videos of the driver's button-pressing position (Such as when the commands are given, what commands are given, what specific hand operations are made, and whether the operations are appropriate), videos of the driver's accelerator pedal position (Such as whether the accelerator pedal is pressed and the range and strength of such foot movement in case of an accident, and whether it is the brake pedal mistakenly pressed instead of the accelerator pedal), videos of the driver's brake pedal position (Such as whether the brake pedal is pressed and the range and strength of such foot movement in case of an accident, and whether it is the accelerator pedal mistakenly pressed instead of the brake pedal), videos of intelligent driving related displays on human-machine interaction interface (For example, changes of vehicle speed during accidents, status of intelligent driving, display of obstacle perception, display of traffic light perception, display of lane line perception, display of traffic sign perception, status of positioning, status of digital map, combination of positioning and digital map, route planning information, planning information of maneuvering actions, execution details of maneuvering actions, and other information related to intelligent driving). Additionally, videos of people or goods inside the vehicle could also be recorded (recording the impact or harm caused by accidents to people or goods). At the same time, corresponding to videos above, it is best to further collect and record time-synchronized audio information (such as intelligent voice broadcasting and system prompt sound that reflect the details of the intelligent driving navigation and maneuvering process, such as commands given by person in the vehicle through voice), positioning information (comparing the positioning performance of the non-vehicle equipment with that of the vehicle built-in equipment), time information (providing accurate and unified timeline for recording).

Please note that the above “changes of vehicle speed during accidents, status of intelligent driving, display of obstacle perception, display of traffic light perception, display of lane line perception, display of traffic sign perception, status of positioning, status of digital map, combination of positioning and digital map, route planning information, planning information of maneuvering actions, execution details of maneuvering actions, and other information related to intelligent driving” all belong to “information related to intelligent driving”. Obviously, vehicle air conditioning control information, atmosphere light control information, music play information, entertainment video play information, etc. do not belong to “information related to intelligent driving”. The term “information related to intelligent driving” mentioned in this patent is defined literally and can be easily concluded or judged based on common sense. For the vast majority of intelligent vehicles, these “information related to intelligent driving” are mostly displayed in real-time on the human-machine interaction interface, since different manufacturers and product models adopt different designs, some are displayed on the instrument panel (dashboard), some are displayed on the central control (screen), some are displayed at both places, and some information is broadcast through intelligent voice.

The term “human-machine interaction interface” mentioned in this patent includes but is not limited to instrument panel (dashboard), central control (screen), and intelligent cockpit. The so-called “instrument panel (dashboard)” refers to a centralized instrument display, which generally refers to the indicating devices and display interfaces that reflect the working status of various systems of the vehicle, indicating not only traditionally the status of fuel volume, fluid temperature, light signal, door opening and closing, but also displaying various status and information closely related to intelligent driving. The so-called “central control (screen)” refers to the central control console of a vehicle, which generally refers to the operating devices and display interfaces that control the operations of various systems of the vehicle, in addition to traditional controls such as windows, lights, air conditioning, audio, video, locks, handbrake, etc., it also displays various status and information closely related to intelligent driving, especially because the display screen at the central control can be relatively large and with an unobstructed view, it is often used to display high-definition digital map information related to intelligent driving and other richer intelligent information. For traditional vehicle models, the instrument panel (dashboard) and the central control (screen) are often separated, while for many new vehicle models, the instrument panel (dashboard) and central control (screen) are often mixed together and collectively referred to as the “intelligent cockpit”. The information display positions of the human-machine interaction interface (instrument panel, central control, intelligent cockpit) include but are not limited to the positions behind the steering wheel, in front of the steering wheel, on the steering wheel, at the front windshield (glass projection imaging display), below the front windshield, above the front windshield, at the rearview mirror, at the ceiling, in the middle and front of between the driver's seat and passenger's seat, in the upper part of the glove box position, at the door, at the A-pillar, at the head-up line of sight position (HUD head-up display), at the armrest box. For the intelligent vehicle which the driver is on board, the human-machine interaction interface is also on board; For situation that the driver is outside the vehicle (such as remote control of intelligent vehicles), the human-machine interaction interface is also outside the vehicle.

The term “intelligent driving” mentioned in this patent generally refers to all vehicle automatic intelligent driving functions or modes which attempt to use machine capabilities to assist humans in observation, thinking, decision-making, and operation in vehicle driving, freeing humans from personal observation, thinking, decision-making, and operation on themselves, including but not limited to unmanned driving, autonomous driving, assisted driving, and human-machine co-driving.

The terms “intelligent vehicle”, “intelligent driving vehicle”, and “intelligent connected vehicle” mentioned in this patent refer to all vehicles with intelligent driving capabilities, sometimes the functions or modes of intelligent driving can be turned on or off.

The term “driver” mentioned in this patent refers to any human in an intelligent vehicle who can give commands to control the vehicle's driving, as well as any human outside the intelligent vehicle who can give commands to control the vehicle's driving.

In general, during the intelligent driving process of a vehicle, much data can be obtained from the vehicle built-in sensors and data storage devices, but it requires the cooperation and assistance from the manufacturer to be actually obtained and interpreted by users. Users hope to maintain independence, freely reproduce and examine their experiences, have autonomy and ownership of the corresponding data, obtain their own independent evidence and even send it to technical experts for professional advice or disseminate it to online media to gain public opinion and support. At the same time, users also hope to view the accident process from multiple perspectives such as non-vehicle-equipped-sensor perspectives and some side perspectives, in order to enhance their independent understanding of the accident and avoid excessive reliance on the narrative, judgment, and conclusion out of intelligent driving manufacturers and traffic management authorities.

The traditional automobile Event Data Recording system (EDR) often only records various types of data from the vehicle built-in original sensors, and users often believe that such data does not match their own memory or feeling, and also question the data collecting quality of such vehicle built-in original sensors themselves. Moreover, the traditional automobile Event Data Recording system (EDR) is often triggered by drastic changes in speed, mainly aimed at collecting short-term (usually a few seconds) pre-event, in-event and post-event data during events such as sudden braking or collisions, it does not record the specific early but fleeting events that occurred in the traffic environment at an earlier time leading to intelligent driving accidents (such as the false perception from some specific distant vision by intelligent vehicle's artificial intelligence), it does not record the complete fact chain (i.e. the complete logical chain) that continues for a relatively long time, gradually, sequentially, link by link and step by step causing problems from the earliest errors, failures, and abnormalities, it does not record non-violent situations such as minor scratches or taking wrong routes, and it does not record dangerous driving situations where dangers potentially abound but no actual accidents take place.

The traditional Driving Video Recording system (DVR), mainly collects video from the front view of the vehicle, side or rear situations in accident are generally not recorded, especially not recording the targeted information related to intelligent driving such as the perception results of obstacles by artificial intelligence. By upgrading, the common traditional Driving Video Recording System (dashboard camera, “dashcam” for short, such as anti-blackmail camera or anti-theft camera) collects and records videos of surrounding environment of the vehicle throughout entire driving process, but does not video-shoot the comprehensive information and complete facts related to intelligent driving such as the driver's steering wheel position, operating lever position, button-pressing position, accelerator pedal position, brake pedal position, instrument panel (dashboard) display, central control (screen) display, intelligent cockpit display, etc., especially those targeted detailed information related to intelligent driving AI performance like obstacle perception, lane line perception, traffic light perception, traffic sign perception, positioning details, digital map details, route planning details, maneuver action planning details, and maneuver execution details.

In order to address the above issues and meet user needs, the present invention adopts the following methods:
Using non-vehicle-equipped camera devices and data storage devices, during the operation of the intelligent vehicle, continuously and simultaneously video-shoot and record the external environment of the vehicle, the driver's hand operation positions, the driver's foot operation positions, and the human-machine interaction interfaces in a time-synchronized manner, in order to record the difference, discrepancy or conflict between “cognition, decision-making and execution out of machine” and “purpose, intention and thought out of human”, and independently record the entire process of intelligent driving accidents, in which, the video-shooting at the driver's foot operation positions is mainly targeted to record which specific stepping device the foot stepped on, the degree to which the stepping device was stepped down, and the specific range of the foot-stepping action, the video-shooting of human-machine interaction interfaces is mainly targeted to record information related to intelligent driving among all information displayed;
In addition, simultaneously and time-synchronously video-shoot and record person or goods inside the vehicle;
In addition, use non-vehicle-equipped device to receive time information provided by external radio signals and synchronize with the video;
In addition, use non-vehicle-equipped device to receive positioning information provided by external radio signals and synchronize with the video;
In addition, use non-vehicle-equipped device to perform time-synchronized audio acquisition and recording;
In addition, shooting illumination is set at the shooting position;
In addition, all records are stored, copied, and played in a time-synchronized manner;
In addition, the data storage device on the vehicle is seal-protected to withstand collision, fire or flooding, without damage or loss.

Corresponding to the aforementioned cases, the beneficial effects brought by this patent are explained as follows.

For Case 1, the intelligent vehicle mistakenly perceives “obstacles” and triggers “ghost braking” or “phantom braking”. Before, during and after such unexpected event, this patented method clearly captures and records the normal traffic environment that is factually free of obstacles, and some certain momentary “suspicious scenes” that may be identified and judged by artificial intelligence professionals as abnormality such as a special light and shadow contour that makes the intelligent vehicle's visual artificial intelligence mistakenly perceives as “a large truck suddenly appears at a close distance ahead”. At that moment, this patented method captures and records the specific obstacles that the artificial intelligence “thinks” it “sees” which displays on the human-machine interaction interface, the sharp decrease of vehicle speed caused by emergency braking which displays on the human-machine interaction interface, and the brake pedal at the foot operation position not being pressed by the driver's foot. This patented method also captures and records, if no accident occurs, the discomfort of sudden leaning forward, panic and dissatisfaction of the person inside the vehicle. If unfortunately encountering a meaningless and evitable rear end collision, corresponding violent vibrations are also captured and recorded. By synchronizing and playing the entire process of video and audio with time and positioning information, the entire process of such unexpected causes and consequences can be fully and completely reproduced. Users can use such process reproduction as basis and evidence to defend their rights against manufacturers and demand compensation, or to complain to regulatory authorities. Users have the right to claim that “such intelligent driving artificial intelligence has product defects and safety hazards”.

For Case 2, the intelligent vehicle fails to correctly perceive obstacles and leads to collision (even if the driver intervenes with all his might). Before, during and after such unexpected event, this patented method clearly captures and records the specific obstacles in the traffic environment ahead and the entire process of collision, captures and records the human-machine interaction interface displaying the artificial intelligence “sees no obstacle” and the speed display shows no deceleration at all. When notices that “the intelligent driving artificial intelligence sees no obstacle” or “the intelligent driving operates no deceleration at all”, the driver under panic immediately intervenes with all his strength to take over, such specific timing, specific actions, and such entire process (such as emergency brake at the foot operation position, control of the steering wheel at the hand operation position), as well as the detailed process of the vehicle's corresponding speed decreasing until the collision, are captured and recorded. By synchronizing and playing the entire process of video and audio with time and positioning information, the entire process of such unexpected causes and consequences can be fully and completely reproduced. Users can use such process reproduction as basis and evidence to defend their rights against manufacturers and demand compensation, or to complain to regulatory authorities, or to initiate legal proceedings. Users have the right to claim that “they themselves have implemented the most appropriate intervention and takeover within their full capabilities with the correct vigilant focus and the fastest reasonable response, and intelligent driving manufacturers should bear partial or full responsibility for the accident due to such product design defects”.

For Case 3, the intelligent vehicle performs incorrect visual perception on infinitely changing world elements. Before, during and after such unexpected event, this patented method clearly captures and records the overall and detailed image of roadside billboards, or the specific style, size and color of roadside fast food restaurant signs, or the specific height, view angle, color and outline of the moon, as well as their visual changing process from far to near and from blurry to clear. The corresponding human-machine interaction interface is captured and recorded with the specific display of “speed limit signs”, “stop signs”, “traffic lights yellow light on” perceived wrongly by artificial intelligence, with the timing and the specific process of corresponding changes of vehicle speed. The video-shooting at the foot operation position proves that the vehicle speed change is not caused by the driver's foot movements. Rear vehicle's abnormal actions in corresponding emergency deceleration such as “head nodding”, flashing lights to urge, and detour overtaking are captured and recorded. Inexplicable or incomprehensible experience of dissatisfied driver and passengers are also captured and recorded. By synchronizing and playing the entire process of video and audio with time and positioning information, the entire process of such unexpected causes and consequences can be fully and completely reproduced. Users can use such process reproduction as basis and evidence to defend their rights against manufacturers and demand compensation, or to complain to regulatory authorities, or to initiate legal proceedings. Users have the right to claim that “such intelligent driving artificial intelligence has product defects”.

For Case 4, the intelligent vehicle mistakenly perceives white stains on the road surface as lane markings and dangerously deviates in direction. Before, during and after such unexpected event, this patented method clearly captures and records the color, size, contour, and incorrect extension direction of those stains on the road surface in front of the right front wheel, as well as the yaw angle, driving speed, and steering range along this incorrect extension direction, while heading towards the cement isolation strip in the center of the road. It clearly captures and records the lane line incorrectly perceived by artificial intelligence displayed on the human-machine interaction interface, and the true position, color, size, contour, and correct extension direction of the genuine normal lane markings at the front road of external environment. It captures and records the driver's intervention that is almost too late, the sudden right turn of the vehicle caused by driver's emergency drastic pulling on the steering wheel, and the consequential rapid left and right swaying instability of the vehicle. It also captures and records at the hand operation position for the complete reaction process, specific intervention actions, specific timing, action intensity and range during the emergency in which the driver intervenes in sudden panic and regains control of the vehicle by drastically pulling steering wheel. The process of hasty dodging of nearby vehicles on verge of being collided is also captured and recorded. By synchronizing and playing the entire process of video and audio with time and positioning information, the entire process of such unexpected causes and consequences can be fully and completely reproduced. Users can use such process reproduction as basis and evidence to defend their rights against manufacturers and demand compensation, or to complain to regulatory authorities, or to initiate legal proceedings. Users have the right to claim that “such intelligent driving artificial intelligence has product defects and safety hazards”.

For Case 5, due to the lack of world knowledge and common sense, the intelligent vehicle perceives everything as potential obstacle so inexplicably performs sudden brakes. Before, during and after such unexpected event, this patented method clearly captures and records the texture, color, contour of the plastic bag flying ahead, as well as its flying movement, height, position, and direction. The human-machine interaction interface displaying what kind of obstacle the artificial intelligence perceives such plastic bag as, and the sudden speed decrease to zero, are captured and recorded. It is captured and recorded that such drastic speed change is not caused by the foot movements of the driver at the foot operation position. The sudden forward leaning and panic of the person inside the vehicle are also captured and recorded. If unfortunately encountering a meaningless rear end collision, corresponding severe vibrations are also captured and recorded. By synchronizing and playing the entire process of video and audio with time and positioning information, the entire process of such unexpected causes and consequences can be fully and completely reproduced. Users can use such process reproduction as basis and evidence to defend their rights against manufacturers and demand compensation, or to complain to regulatory authorities, or to initiate legal proceedings. Users have the right to claim that “such intelligent driving artificial intelligence has product defects and safety hazards, and intelligent driving manufacturers should bear partial or full responsibility for accidents due to such product design defects”.

For Case 6, the intelligent driving artificial intelligence mistakenly perceives traffic signs or instructions due to noises, disturbances and perturbations. Before, during and after such unexpected event, this patented method clearly captures and records the specific abnormal situations such as mud, reflection, discoloration, deformation, and skewness of roadside traffic signs, and their specific perception results by artificial intelligence, and the corresponding changes in driving planning (route planning and action planning) displayed on the human-machine interaction interface. It is captured and recorded that the specific maneuvering actions chosen and executed by intelligent vehicles such as automatic steering of the steering wheel at the hand operation position, as well as the specific detailed scene that the driver becomes panicked when realizing an error occurs but is unable to successfully save the situation even if he intervenes and takes over with full capacity of hands and feet (the vehicle maneuver has already been made). If an accident unfortunately occurs, the various steps and full process from artificial intelligence misperception to the occurrence of the accident are captured and recorded. By synchronizing and playing the entire process of video and audio with time and positioning information, the entire process of such unexpected causes and consequences can be fully and completely reproduced. Users can use such process reproduction as basis and evidence to defend their rights against manufacturers and demand compensation, or to complain to regulatory authorities, or to initiate legal proceedings. Users have the right to claim that “intelligent driving manufacturers should bear partial or full responsibility for traffic violation penalties or accidents caused by intelligent driving due to such product design defects”.

For Case 7, the intelligent vehicle perceives harmless water column, water curtain, and water mist as obstacles and urgently brakes. Before, during and after such unexpected event, this patented method clearly captures and records the specific scene of water column, water curtain, and water mist appearing in real traffic environment, the human-machine interaction interface displaying the specific obstacle perception results out of intelligent driving artificial intelligence, the specific maneuvering performance of drastic decrease of speed. It is captured and recorded that the speed change is not caused by driver's foot movements at the foot operation position. The scene of discomfort and shock among the people inside the vehicle is also captured and recorded. If an accident unfortunately occurs, the various steps and full process from artificial intelligence misperception to the occurrence of the accident are captured and recorded. By synchronizing and playing the entire process of video and audio with time and positioning information, the entire process of such unexpected causes and consequences can be fully and completely reproduced. Users can use such process reproduction as basis and evidence to defend their rights against manufacturers and demand compensation, or to complain to regulatory authorities, or to initiate legal proceedings. Users have the right to claim that “the intelligent driving artificial intelligence is incompetent with insufficient capability and there are safety hazards, and intelligent driving manufacturers should bear partial or full responsibility for traffic accidents due to such product design defects”.

For Case 8, the intelligent vehicle takes abnormal maneuvers due to positioning jumps. Before, during and after such unexpected event, this patented method clearly captures and records the sudden shift or change of vehicle positioning and its relationship with digital map, planning actions and speed that are displayed on the human-machine interaction interface, and the changes of the driving environment around the timing of the positioning jump (such as driving under an elevated bridge, entering and exiting a tunnel, or travelling next to a high-rise building in the city), the normal maneuvers of the vehicle before the timing and the abnormal maneuvers with a surprisingly sudden steering of direction at the timing (sudden drastic direction change of the steering wheel at the hand operation position within a short period of time), the specific hand movements and foot movements out of the driver urgently intervening in panic, and the dangerous process of the vehicle almost colliding with the road separation belt or nearby vehicles. By synchronizing and playing the entire process of video and audio with time and positioning information, the entire process of such unexpected causes and consequences can be fully and completely reproduced. Users can use such process reproduction as basis and evidence to defend their rights against manufacturers and demand compensation, or to complain to regulatory authorities, or to initiate legal proceedings. Users have the right to claim that “such intelligent driving products have design defects and safety hazards”.

For Case 9, the intelligent vehicle hesitates and fails to progress at a busy intersection. Before, during and after such unexpected event, this patented method clearly captures and records the driving environment for the detailed maneuvers of specific traffic participants in all directions of the intersection, and the specific situation of traffic lights and signs at the intersection. It captures and records the perception results of such various traffic participants, traffic lights and signs displayed on the human-machine interaction interface, and the specific ever-changing and constantly-hopping planning information displayed on the human-machine interaction interface. It also captures and records the entire process of driver and passengers enduring from patience to confusion then to dissatisfaction, the angry urge from the rear vehicles, and the driver regretfully and reluctantly intervenes to take over and then easily manages to drive manually through the intersection after a prolonged hesitation and waiting. By synchronizing and playing the entire process of video and audio with time and positioning information, the entire process of such unexpected causes and consequences can be fully and completely reproduced. Users can use such process reproduction as basis and evidence to defend their rights against manufacturers and demand compensation. Users have the right to claim that “such intelligent driving products have incompetently insufficient capability and product defects”.

For Case 10, the intelligent vehicle fails to integrate the newly-constructed available road into the driving route planning. Before, during and after such unexpected event, this patented method clearly captures and records the newly available road for driving in the traffic environment ahead, its absence in the digital map displaying on the human-machine interaction interface but showing other correspondingly unreasonable planning of detour route, and consequentially the specific maneuver actions of the vehicle automatically driving onto the unreasonable route. It also captures and records the dissatisfaction of driver and passengers towards such intelligent driving performance. By synchronizing and playing the entire process of video and audio with time and positioning information, the entire process of such unexpected causes and consequences can be fully and completely reproduced. Users can use such process reproduction as basis and evidence to defend their rights against manufacturers and demand compensation. Users have the right to claim that “such intelligent driving products have incompetently insufficient capability and product defects”.

For Case 11, the intelligent vehicle cannot perceive lane line and sways left and right. Before, during and after such unexpected event, this patented method clearly captures and records the specific abnormality of the lane markings on the road ahead that causes the artificial intelligence to fail to recognize correctly, the dangerous distance to nearby vehicles or road isolation zone when swinging left and right, the rotational speed and range of the automatic steering during the dangerous swaying maneuver, the specific hand movements and foot movements taken by the driver in panic, and the specific perception results of the lane line by artificial intelligence displayed on the human-machine interaction interface throughout the entire process. By synchronizing and playing the entire process of video and audio with time and positioning information, the entire process of such unexpected causes and consequences can be fully and completely reproduced. Users can use such process reproduction as basis and evidence to defend their rights against manufacturers and demand compensation, or to complain to regulatory authorities. Users have the right to claim that “such intelligent driving products have design defects and safety hazards”.

For Case 12, the rigid programming of intelligent vehicle results in frequent and unnecessary sudden braking when following in congestion. Before, during and after such unexpected event, this patented method clearly captures and records the details of the actions of the nearby vehicles being relatively safe in distance but occasionally attempting to merge in traffic congestion, the sudden braking maneuvers when the tires of the nearby vehicle only pressing a little on the markings of the current lane (in some cases the nearby vehicle does not even intend to merge but only drives inaccurately resulting in the tires pressing a little on lane markings), and the corresponding frequent and sharp speed decreases and increases displayed on the human-machine interaction interface. It is captured and recorded that the speed changes are not caused by the foot movements of the driver at the foot operation position. It also captures and records that the driver and passengers of the vehicle frequently experience discomfort of leaning forward due to sudden braking during the entire process, and their anger and helplessness that ultimately unable to tolerate but to take over the vehicle. By synchronizing and playing the entire process of video and audio with time and positioning information, the entire process of such unexpected causes and consequences can be fully and completely reproduced. Users can use such process reproduction as basis and evidence to defend their rights against manufacturers and demand compensation. Users have the right to claim that “such intelligent driving products have design defects”.

For Case 13, the users are unable to determine whether the vehicle is out of control or they make operational mistakes of their own. Before, during and after such unexpected event, this patented method clearly captures and records the driving environment of the vehicle throughout the entire process, the changes of vehicle speed displayed on the human-machine interface corresponding to vehicle control, and the specific timing, range and strength of hand or foot movements at the driver's hand operation positions and foot operation positions, especially the clear, accurate and detailed video records of whether the driver has mistakenly stepped on the wrong pedal, whether the driver has tried hard enough to step on the pedal, the degree to which the pedal has been pressed down, and whether it is true that “the brake pedal could not be stepped down”. In the practical application of intelligent driving, similar problems often arise due to overly complex system design of intelligent vehicle, where a large number of advanced and complex functions such as autonomous driving, assisted driving, kinetic energy recovery, and electronic control systems, etc. are combined and pieced together, therefore various rules, priorities and authorities are intertwining or even conflicting, resulting in system design defects. Some intelligent driving systems are even unintentionally or intentionally designed to grant machine authority over human authority. The sensor data collected by a system with design defects or flaws, even though true and complete and provided by the manufacturer, often cannot explain the problem of such system, because the data that truly explains the problem may not have been collected at the first place, which means, the data is not comprehensive. Therefore, by synchronizing and playing the entire process of video and audio with time and positioning information, the entire process of such unexpected causes and consequences can be fully and completely reproduced. Users can use such process reproduction as basis and evidence to defend their rights against manufacturers and demand compensation, or to complain to regulatory authorities, or to initiate legal proceedings. Users have the right to claim that “such intelligent driving products have design defects and safety hazards”.

For Case 14, the unexpectedly sudden automatic exit of the intelligent driving function or mode results in the driver not being able to properly take over in time. Before, during and after such unexpected event, this patented method clearly captures and records the timing, process, takeover-prompting method, and changes in display shown on the human-machine interaction interface when the intelligent driving function or mode unexpectedly exits. It captures and records the corresponding intelligent voice broadcast and system prompt sound throughout the entire process, the specific driving environment as well as the information of positioning and map changes displayed on the human-machine interaction interface (to help infer what specific situation causes the sudden exit of intelligent driving). It captures and records the specific hand movements and foot movements of the driver who is caught off guard and hastily intervenes to take over, resulting in a scene of perilous situation. By synchronizing and playing the entire process of video and audio with time and positioning information, the entire process of such unexpected causes and consequences can be fully and completely reproduced. Users can use such process reproduction as basis and evidence to defend their rights against manufacturers and demand compensation, or to complain to regulatory authorities, or to initiate legal proceedings. Users have the right to claim that “such intelligent driving products have design defects and safety hazards”.

For Case 15, the user takes action of takeover improperly or excessively during the scare caused by intelligent driving and results in an accident. Before, during and after such unexpected event, this patented method clearly captures and records the driving environment of the entire process. It captures and records the incorrect perception, improper planning of dangerous maneuvers of intelligent driving displayed on the human-machine interaction interface, as well as the specific experience of nervousness and fright that intelligent driving brings to users (such as the unstable, unsmooth, and untimely steering adjustment when the intelligent vehicle turns at high speed, leading to the vehicle suddenly approaches too close to the guardrail). It captures and records the hesitant actions of the driver at the critical point estimating the extent of danger before intervention (such as stiffly placing hand on the steering wheel or foot on the brake pedal but not turning or pressing due to hesitation) at the hand operation position and foot operation position. It also captures and records the driver's specific facial-expression, demeanor, and the strength and range of hand and foot operational movements when intervene (such as the panicked driver suddenly realizing the danger drastically turns the steering wheel to the opposite direction of the guardrail while sharply pressing the brake), and the process of the subsequent accident (such as the vehicle loses control due to drastic steering and collides with nearby vehicles). By synchronizing and playing the entire process of video and audio with time and positioning information, the entire process of such unexpected causes and consequences can be fully and completely reproduced. Users can use such process reproduction as basis and evidence to defend their rights against manufacturers and demand compensation, or to complain to regulatory authorities, or to initiate legal proceedings. Users have the right to claim that “such intelligent driving products are incompetent with insufficient capability, the manufacturers should be partially or fully responsible for the accident”.

Due to the possibility of collision, fire, water immersion and other situations caused by serious accidents, the corresponding data storage devices set on the vehicle is possible to be damaged and the accident-related evidence is possible to be lost, so this patent sets a high requirement for data storage devices installed on vehicles to be able to withstand collisions, fires, and flooding without damage or loss. Therefore, this patent sets seal-protection for storage devices installed on vehicles.

One implementation example is to simultaneously use multiple cameras to continuously video-shoot and record the vehicle's external environment, driver's hand operation positions, driver's foot operation positions, and human-machine interaction interfaces in a time-synchronized manner. Each camera is installed and adjusted by the user according to the vehicle's specific conditions to adopt appropriate angles, illumination, and clarity. All camera devices are set to capture and record: Videos of the vehicle's external traffic environment (such as what specific obstacle is mistakenly perceived), which can include visual angles and shooting methods in forward, lateral, backward, wide-angle and other perspectives; Videos of the driver's steering wheel positions (such as the detailed actions of the driver's emergency intervention in panic), which can include the panoramic view of the steering wheel, the view of driver's upper body, and a close-up view of the driver's hand operation on the steering wheel; Videos of the driver's operating lever positions (such as when and how the driver uses hand to operate the lever and what commands are given), which can include the panoramic view of the operating lever behind the steering wheel, the panoramic view of the operating lever at the instrument panel (dashboard), the panoramic view of the operating lever at the central control console, the panoramic view of the operating lever at the armrest box, and a close-up view of the driver's hand operation on the operating lever; Videos of the driver's button-pressing positions (such as when and how the driver uses hand to press button and what commands are given), which can include the panoramic view of the buttons at the instrument panel (dashboard), the panoramic view of the buttons at the central control console, and the close-up view of the driver's hand operation on the buttons; Videos of the driver's accelerator pedal position (such as whether the accelerator pedal is pressed down, and the timing, action, range and strength of the pedaling during accident), and of the driver's brake pedal position (such as whether the brake pedal is pressed down, and the timing, action, range and strength of the pedaling during accident), additional illumination can be set at the foot position where is often dark for video-shooting; Videos of the display content on the instrument panel (dashboard), central control (screen), and intelligent cockpit (such as changes of vehicle speed, intelligent driving status, obstacle perception results, traffic light perception results, lane line perception results, traffic sign perception results, planning of routes and actions, combination of positioning and digital map, action execution information, etc. during accident). For different vehicle models, the steering wheel positions, operating lever positions, button-pressing positions and pedal positions often vary, and the intelligent driving related information displayed on the instrument panel (dashboard), central control (screen) and intelligent cockpit also has significant differences in various details, therefore, it is reasonable and effective for users to install and adjust the position, perspective, illumination of each camera based on their specific vehicle model. The above steering wheel positions, operating lever positions, button-pressing positions, accelerator pedal positions, brake pedal positions, etc. all correspondingly belong to the driver's hand operation positions or the driver's foot operation positions.

Another implementation example is that the intelligent vehicle does not have traditional driving control devices such as steering wheel and pedals, but always provides devices for braking, door opening, alarm, calling for help, etc. for human passengers in case of emergencies. The fastest and most convenient device operation method to ensure passenger safety is still to operate by humans using their hands or feet, therefore, such devices also belong to the driver's hand operation positions or the driver's foot operation positions, this patented method also performs video-shooting at these positions.

Another implementation example is that when a driver outside the intelligent vehicle remotely controls the intelligent vehicle, this patent method can also be used to video-shoot the driver's hand operation positions, the driver's foot operation positions, and the human-machine interaction interfaces outside the intelligent vehicle, with camera devices inside or outside the vehicle video-shooting the vehicle's external environment. In this way, the driver and users record the difference, discrepancy or conflict between ‘cognition, decision-making and execution out of machine’ and ‘purpose, intention and thought out of human’, and independently record the entire process of intelligent driving accidents.

Furthermore, it is feasible to simultaneously capture and record the videos of people or goods inside the vehicle to record the impact or harm caused by accidents. Non-vehicle equipment can also be used to process radio signals from the Global Positioning System (GPS), the Beidou system, or roadside intelligent transportation infrastructure to synchronously collect and record time and positioning information. It is also feasible to use a microphone that is not originally equipped in the vehicle to synchronously collect and record audio information, recording the driver's voice of giving intelligent driving related commands to the intelligent vehicle, the continuous intelligent voice broadcasting of intelligent driving, and the system prompt sounds of intelligent driving.

All video, audio, time, and positioning information mentioned above are strictly synchronized, and all records can be stored, copied and played in a time-synchronized manner. For data storage, the record data can be stored either on storage device in the vehicle or wirelessly transmitted to storage device outside the vehicle. For data playback, videos from all shooting angles can be simultaneously played on the same screen with time and positioning information displaying in a time-synchronized manner. Combined with synchronized audio, the complete process and comprehensive information of the unexpected events can be visually and audibly represented and exhibited on the same timeline.

By applying this patented method, user purchases, installs and uses personal private device product corresponding to this patented method, instead of using the vehicle built-in original cameras, microphones and other sensors, the data collected and recorded naturally belongs to the individual user. Consumers can easily access the data on their own in order to reproduce the entire accident process with all the steps and details from multiple perspectives, help themselves recall and analyze, and form comprehensive and complete evidence for safeguarding their legitimate rights and interests.

1. A method for recording independent evidence and complete facts of accidents in intelligent driving, characterized in that: using non-vehicle-equipped camera devices and data storage devices, during the operation of the intelligent vehicle, continuously and simultaneously video-shoot and record the external environment of the vehicle, the driver's hand operation positions, the driver's foot operation positions, and the human-machine interaction interfaces in a time-synchronized manner, in order to record the difference, discrepancy or conflict between “cognition, decision-making and execution out of machine” and “purpose, intention and thought out of human”, and independently record the entire process of intelligent driving accidents, in which, the video-shooting at the driver's foot operation positions is mainly targeted to record which specific stepping device the foot stepped on, the degree to which the stepping device was stepped down, and the specific range of the foot-stepping action, the video-shooting of human-machine interaction interfaces is mainly targeted to record information related to intelligent driving among all information displayed.

2. The method of claim 1, characterized in that: simultaneously and time-synchronously video-shoot and record person or goods inside the vehicle.

3. The method of claim 1, characterized in that: use non-vehicle-equipped device to receive time information provided by external radio signals and synchronize with the video.

4. The method of claim 1, characterized in that: use non-vehicle-equipped device to receive positioning information provided by external radio signals and synchronize with the video.

5. The method of claim 1, characterized in that: use non-vehicle-equipped device to perform time-synchronized audio acquisition and recording.

6. The method of claim 1, characterized in that: shooting illumination is set at the shooting position.

7. The method of claim 1, characterized in that: all records are stored, copied, and played in a time-synchronized manner.

8. The method of claim 1, characterized in that: the data storage device on the vehicle is seal-protected to withstand collision, fire or flooding, without damage or loss.
